(19) United States
(12) Patent Application Publication
(10) Pub. No.: US 2007/0132938 A1
(43) Pub. Date: Jun. 14, 2007

(54) Foldable lens assembly

(76) Inventor: Yung-Ming Huang, Lu-Chou City (TW)

Correspondence Address: LADAS & PARRY, 5670 WILSHIRE BOULEVARD, SUITE 2100, LOS ANGELES, CA, 90036-5679, US

(21) Appl. No.: 11/297,514

(22) Filed: Dec. 8, 2005

(51) Int. Cl. G02C 5/00

(52) U.S. Cl. 351/41

(57) ABSTRACT

A foldable lens assembly comprises a pair of lenses, and a frame connected to the lenses. The frame has at least two components which are interconnected pivotally so that said frame can be folded and unfolded. Each component has at least one abutment face and a magnet. The abutment faces of the components are movable away from or towards each other when the frame is folded or unfolded. The abutment faces abut against each other by attraction of the magnets when the abutment faces move towards each other.

### BACKGROUND OF THE INVENTION

1. Field of the Invention

The invention relates to a lens assembly, more particularly to a foldable lens assembly.

2. Description of the Related Art

Eyeglasses frames have been provided with various foldable constructions to minimize the size of the eyeglasses frames when they are not in use. However, there has not been suggested any foldable structure for a conventional front lens assembly which is attachable to an eyeglasses assembly. When an eyeglasses assembly with a front lens assembly is used outdoors, the front lens assembly cannot be put into a small bag, or a pocket after it is detached from the eyeglasses assembly. Therefore, storage of the conventional front lens assembly is inconvenient, especially when the front lens assembly is used outdoors.

### SUMMARY OF THE INVENTION

Therefore, an object of the present invention is to provide a foldable lens assembly which is foldable into a compact size for convenient storage and which is yet stable in an unfolded position.

According to the present invention, a foldable lens assembly comprises a pair of lenses and a frame holding the lenses. The frame has at least two components which are interconnected pivotally so that the frame can be folded and unfolded. Each of the components has at least one abutment face and a magnet. The abutment faces of the components are movable away from or towards each other when the frame is folded or unfolded. The abutment faces of the components abut against each other when the abutment faces move towards each other. The magnets provides an attraction force so that the abutment faces abut against each other firmly.

### BRIEF DESCRIPTION OF THE DRAWINGS

Other features and advantages of the present invention will become apparent in the following detailed description of the preferred embodiments with reference to the accompanying drawings, of which:

FIG. 1 is a top view of the first preferred embodiment of a foldable lens assembly according to the present invention;

FIG. 2 is a sectional view taken along line 2-2 of FIG. 1;

FIG. 3 is a top view of the first preferred embodiment in a folded state;

FIG. 4 is a top view of the second preferred embodiment of the present invention;

FIG. 5 is a partly exploded perspective view of the second preferred embodiment;

FIG. 6 is a sectional view taken along line 6-6 of FIG. 4;

FIG. 7 is a sectional view taken along line 7-7 of FIG. 4;

FIG. 8 is a top view of the second preferred embodiment in a folded state;

FIG. 9 is a top view of the third preferred embodiment of the present invention;

FIG. 10 is a sectional view taken along line 10-10 of FIG. 9;

FIG. 11 is a top view of the fourth preferred embodiment of the present invention;

FIG. 12 is an exploded view illustrating the fourth preferred embodiment;

FIG. 13 is the same view as FIG. 11 but with a pair of temples being folded;

FIG. 14 is the same view as FIG. 11 but with lens frames and temples being folded;

FIG. 15 is a top view of the fifth preferred embodiment;

FIG. 16 is the same view as FIG. 15, but with temples of the eyeglasses assembly being folded; and

FIG. 17 is the same view as FIG. 15, but with temples and a lens frame being folded.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

The foldable lens assembly according to the present invention may be an eyeglasses assembly, a front lens set attachable to the eyeglasses assembly, or a combination of the eyeglasses assembly and the front lens set. The foldable lens assembly primarily includes a foldable frame that is connected to a pair of lenses and that includes at least two or more pivotally interconnected components.

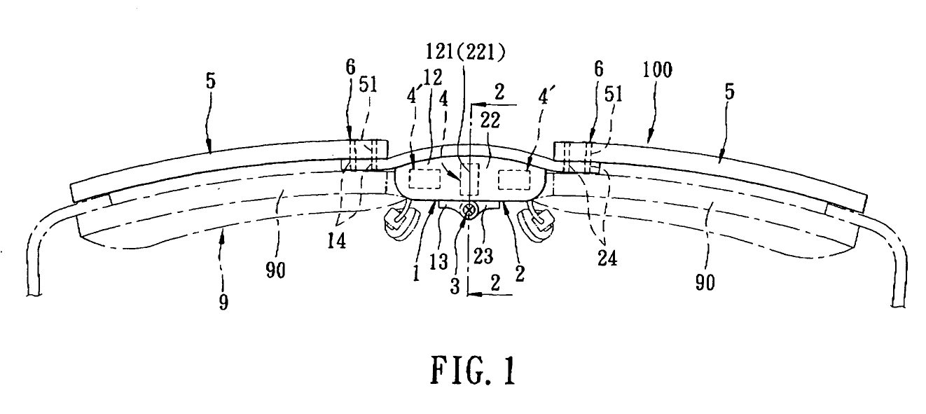

Referring to FIGS. 1, 2 and 3, there is shown a first preferred embodiment of the invention which includes a front lens set 100 attachable to an eyeglasses assembly 9. The front lens set 100 includes a frame having first and second connectors 1, 2 (two pivotal components), a pair of lenses 5 and first magnets 4.

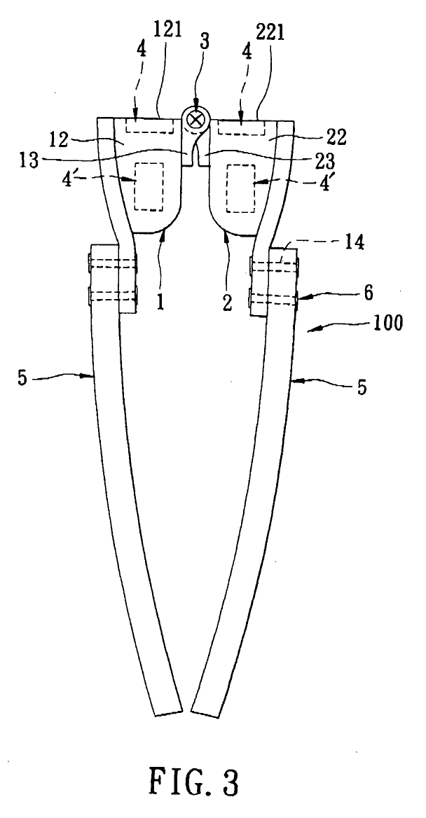

Each of the first and second connectors 1, 2 includes a coupling portion 12, 22 having an abutment face 121, 221, and a hinge portion 13, 23 connected to the coupling portion 12, 22. The first and second connectors 1, 2 are mirror images of each other. The coupling portions 12, 22 are substantially coplanar when the abutment faces 121, 221 abut against each other as shown in FIG. 1. The abutment faces 121, 221 may be separated from each other as shown in FIG. 3.

Each of the coupling portions 12, 22 of the first and second connectors 1, 2 is formed with two through holes 14, 24 and two fasteners 6. Each fastener 6 extends through one of the through holes 14, 24 of the coupling portions 12, 22 and one of through holes 51 provided in one of the lenses 5 so that the lenses 5 are connected respectively to the coupling portions 12, 22. In this embodiment, each fastener 6 is a rivet for riveting one of the lenses 5 to the corresponding coupling portion 12, 22.

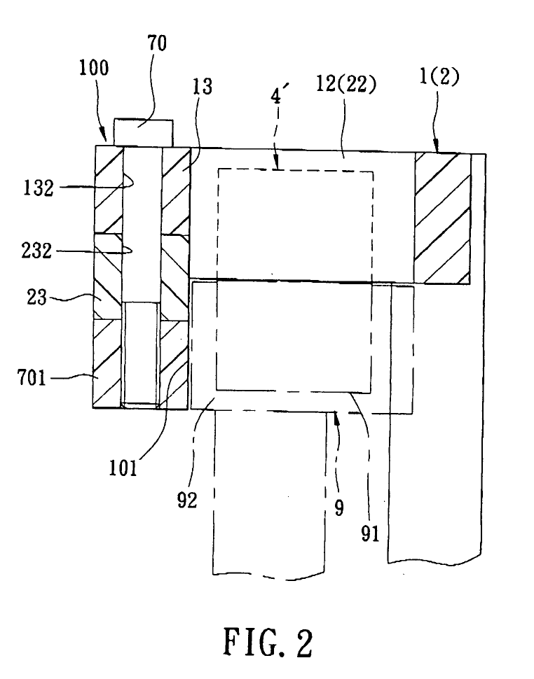

Referring once again to FIG. 2, the hinge portions 13, 23 are connected to the respective coupling portions 12, 22. Each hinge portion 13, 23 is formed with a pivot hole 132, 232. The front lens set 100 further comprises a pivot bolt 70 which interconnects pivotally the hinge portions 13, 23 by extending through the pivot holes 132, 232. A nut 701 is engaged with a bottom end of the pivot bolt 70. As the hinge portions 13, 23 of the first and second connectors 1, 2 are connected pivotally to each other, the frame or the first and second connectors 1, 2 may be folded or unfolded.

The first magnets 4 are respectively embedded in the coupling portions 12, 22 of the first and second connectors 1, 2 adjacent to the abutment faces 121, 221.

The abutment faces 121, 221 of the coupling portions 12, 22 of the first and second connectors 1, 2 abut against each other through the magnetic attraction of the first magnets 4 when the first and second connectors 1, 2 are unfolded in a state of use, as best shown in FIG. 1. The abutment faces 121, 221 are separated from each other when the first and second connectors 1, 2 are folded, as best shown in FIG. 3.

The front lens set 100 further includes two second magnets 4′ embedded in the coupling portions 12, 22, respectively. The eyeglasses assembly 9 includes a pair of lens rims 90 and a bridge 92 that is connected between the lens rims 90 and that has a third magnet 91 embedded therein. When the front lens set 100 is attached to the eyeglasses assembly 9, the coupling portions 12, 22 of the first and second connectors 1, 2 are placed on the bridge 92 so that the second and third magnets 4′, 91 attract each other to retain the front lens set 100 on the eyeglasses assembly 9. In this embodiment, the third magnet 91 is embedded in a bridge 92 of the eyeglasses assembly 9, whereas the second magnets 4′ are embedded respectively in the coupling portions 12, 22.

Referring further to FIGS. 1 and 2, the coupling portions 12, 22 are coplanar with each other, whereas the hinge portions 13, 23 are stacked on the nut 31. The stack of the hinge portions 13, 23 and the nut 31 projects downwardly and rearwardly of the coplanar coupling portions 12, 22.

Therefore, when the first and second connectors 1, 2 are unfolded and when the coplanar coupling portions 12, 22 are placed on the bridge 92 of the eye glasses assembly 9 as shown in FIG. 2, an inner surface 101 defined by the stack of the hinge portions 13, 23 and the nut 701 can engage the bridge 92 if the front lens set 100 moves forwardly from the eyeglasses assembly 9. In other words, the front lens 100 can be limited from moving away from the bridge 92 undesirably. Moreover, the second magnets 4′ of the coupling portions 12, 22 and the third magnet 91 of the bridge 92 attract each other, thereby retaining firmly the front lens set 100 on the eyeglasses assembly 9. The attraction force between the first magnets 4 of the coupling portions 12, 22 can prevent separation of the coupling portions 12, 22 even if the hinge portions 13, 23 become loosened.

When the first and second connectors 1, 2 are folded, the abutment faces 121, 221 of the coupling portions 12, 22 are separated from each other as shown in FIG. 3. The size of the front lens set 100 is therefore reduced so that the front lens set 100 may be put into a waist pocket, or hung on a lateral side of a handbag.

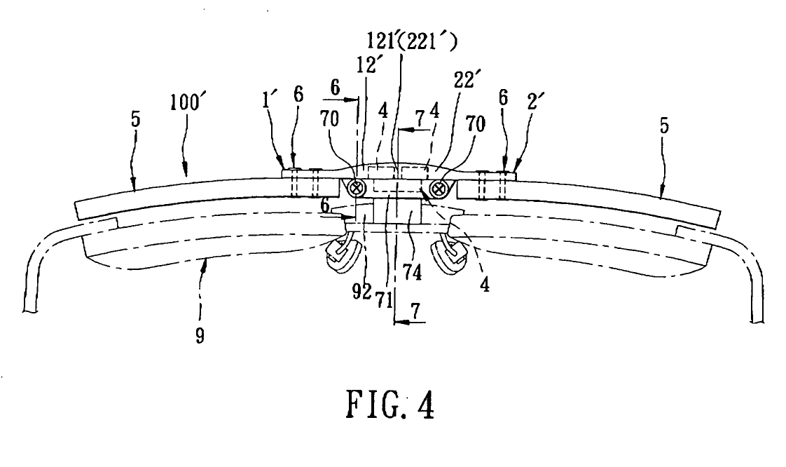

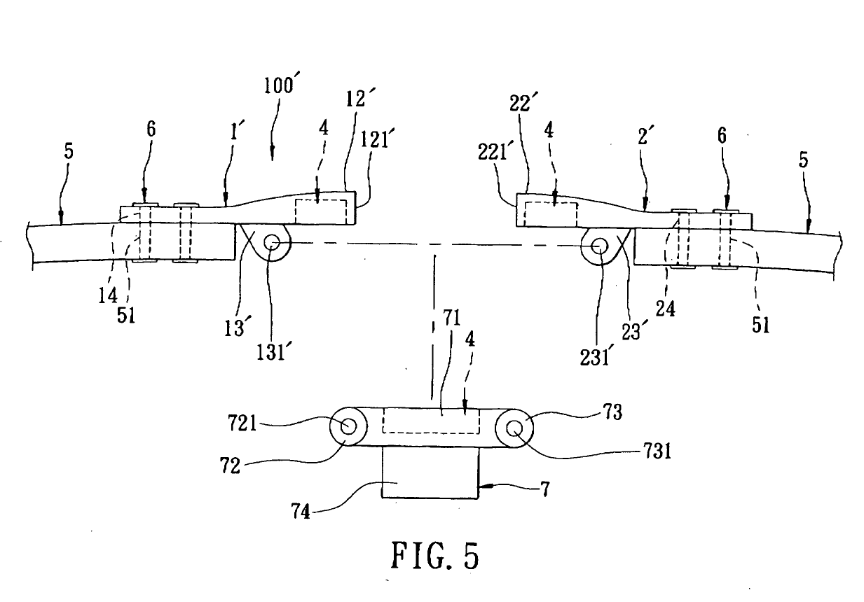

Referring to FIGS. 4 and 5, a front lens set 100, according to the second embodiment of the present invention includes first and second connectors 1′, 2′, two pivot bolts 3, first magnets 4, a pair of lenses 5, a hinge member 7, and fasteners 6. Each of the first and second connectors 1′, 2′ includes a coupling portion 12′, 22′ and a hinge portion 13′, 23′. The coupling portions 12′, 22′ have respective abutment faces 121′, 221′.

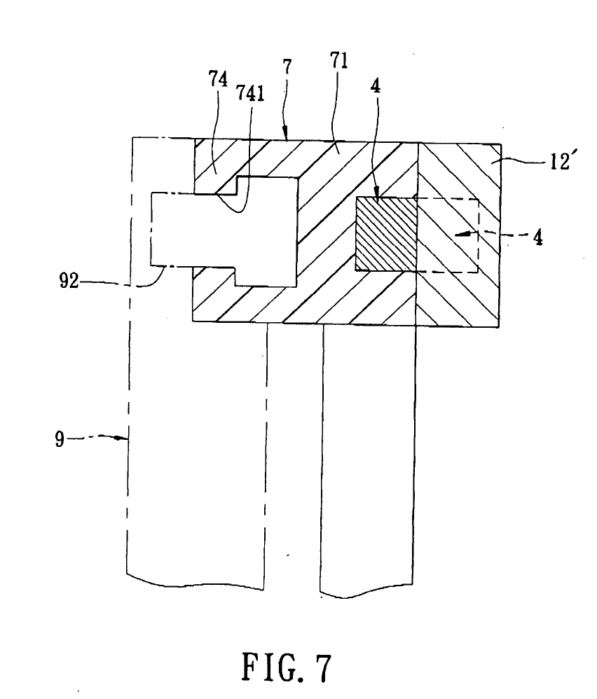

The hinge member 7 is a molded plastic body formed by injection molding and has no magnetic property. The hinge member 7 includes a main part 71, two hinge parts 72, 73 provided on left and right sides of the main part 71, and a bridge engaging part 74 projecting rearwardly from the main part 71 between the hinge parts 72, 73. The bridge engaging part 74 has an engaging groove 741 (FIG. 7) to receive and engage the bridge 92 of the eye glasses assembly 9.

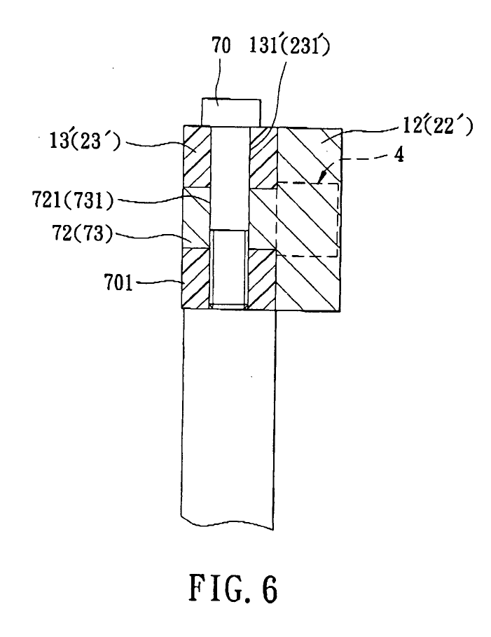

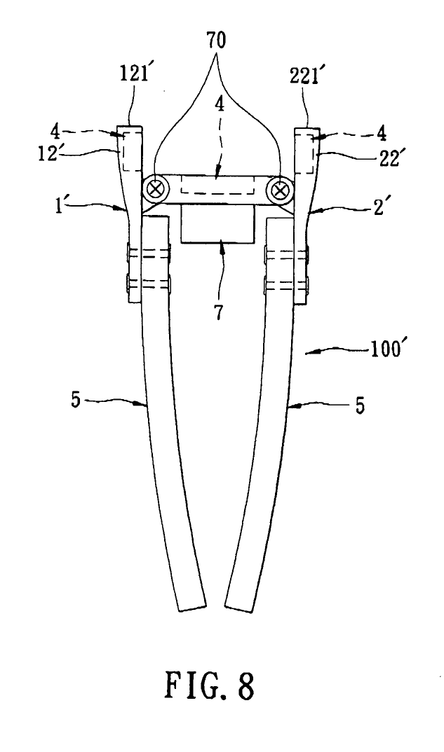

Referring to FIG. 6, The hinge parts 72, 73 are formed respectively with pivot holes 721, 731 that are aligned with the pivot holes 131, 132 of the hinge portions 13, 23, respectively. Each pivot bolt 70 is extended through the pivot hole 721, 731 of the corresponding hinge part 72, 73 and the pivot hole 131′, 132′ of the corresponding hinge portion 13′, 23′. Due to the presence of the hinge member 7, the hinge portions 13′, 23′ of the first and second connectors 1′, 2′ are pivotable relative to each other so that the first and second connectors 1′, 2′ may be folded as shown in FIG. 8, or unfolded as shown in FIG. 4.

Referring once against to FIG. 7, first magnets 4 are disposed in the coupling portions 12′, 22′ of the first and second connectors 1′, 2′ and the main part 71 of the hinge member 7, respectively. Therefore, when the first and second connectors 1′, 2′ are unfolded in a state of use, as shown in FIG. 4, the abutment faces 121′, 221′ of the coupling portions 12′, 22′ of the first and second connectors 1′, 2′ abut against each other by means of the first magnets 4. The front lens set 100′, after unfolded, may be attached to the eye glasses assembly 9 by engaging the bridge 92 of the eye glasses assembly 9 in the engaging groove 741 of the bridge engaging part 74.

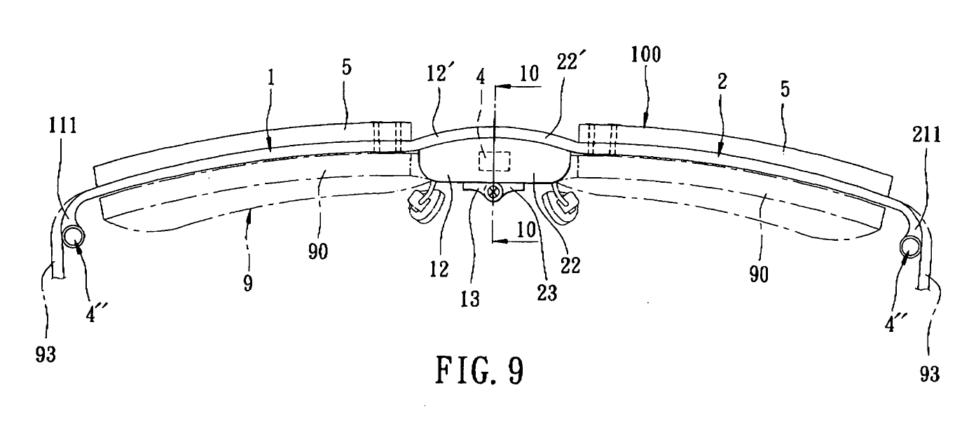

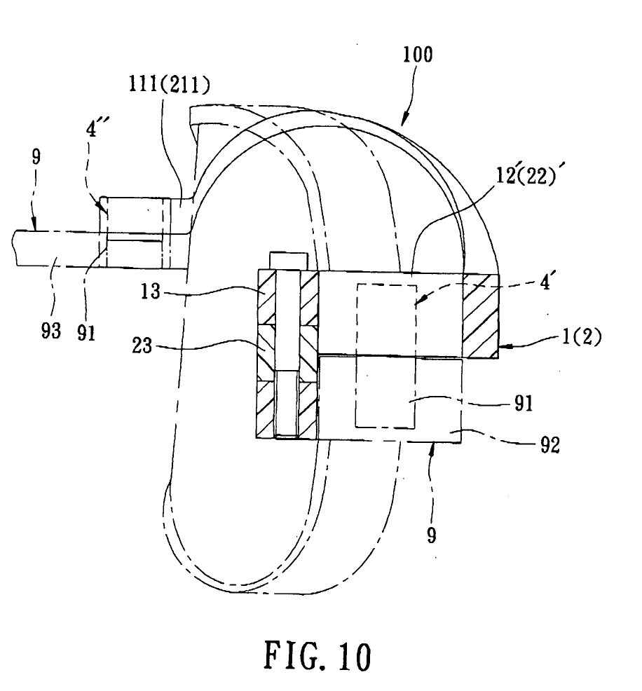

FIGS. 9 and 10 illustrate the third preferred embodiment of the present invention which is substantially similar to the first preferred embodiment except that the coupling portions 12′, 22′ of the first and second connectors 1, 2 have extended sections 111, 211 extending to temples 93 of the eye glasses assembly 9. Magnets 4″ are respectively embedded in the extended sections 111, 211 proximate to the temples 93. The temples 93 are respectively provided with another magnets 91 to interact with the magnets 4″.

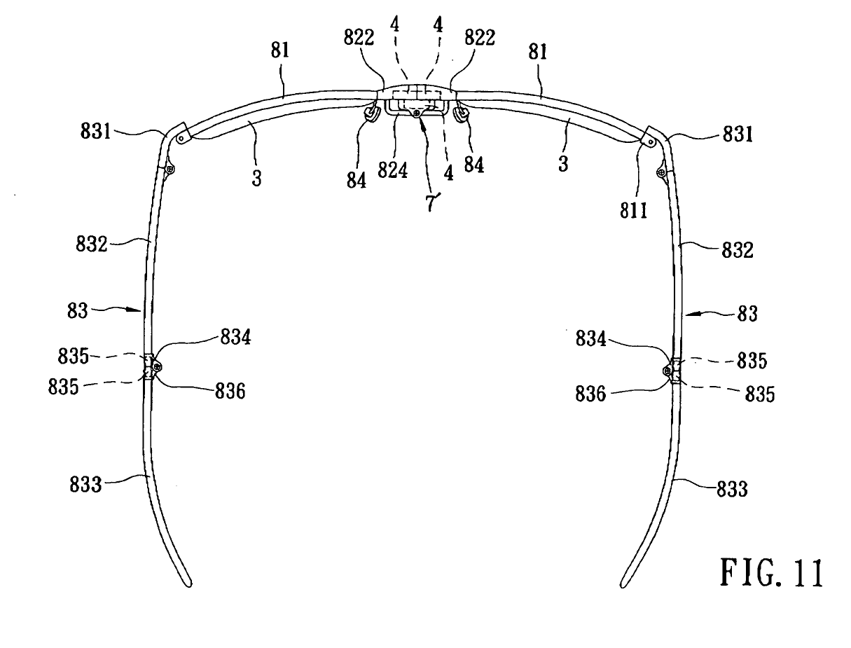

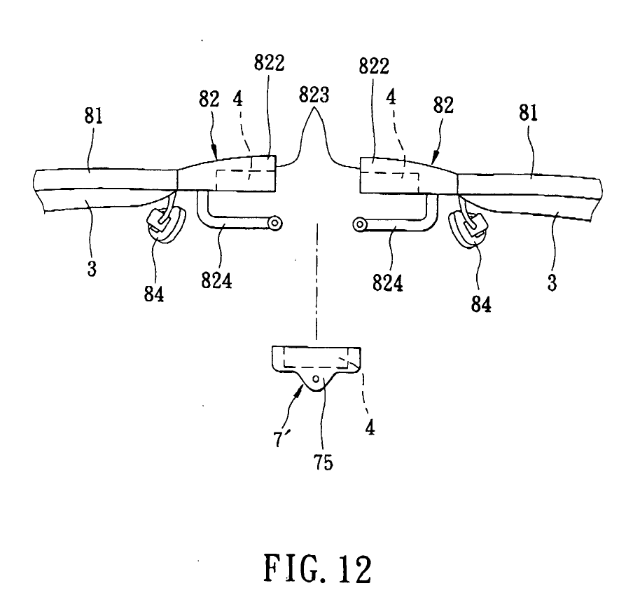

Referring to FIGS. 11 and 12, there is shown an eyeglasses assembly according to the fourth preferred embodiment of the present invention. The eyeglasses assembly comprises a frame that includes a pair of lens rims 81 connected respectively to two symmetrical first and second connectors 82, a pair of lenses 3, a pair of temples 83, a pair of nose pads 84.

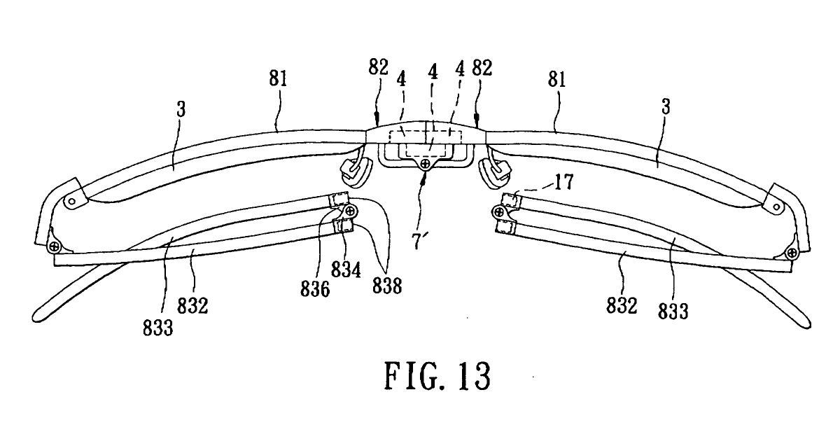

Each temple 83 includes a front end 831 and first and second temple sections 832 and 833. The first and second temple sections 832 and 833 include respective first and second pivot members 834 and 836, respective magnets 835, and respective abutment faces 838 (see FIG. 13). The first and second pivot members 834, 836 of the first and second temple sections 832, 833 are connected pivotally to each other. The abutment faces 838 abut against each other when each temple 83 is unfolded, and the magnets 835 provide an attraction force to hold the abutment faces 838 together firmly.

The lenses 3 are held by the respective lens rims 81. The nose pads 84 are attached to the lens rims 81, respectively. The lens rims 81 are in turn connected integrally with first and second connectors 82, respectively. Each lens rim 81 includes a fixing part 811 connected to the front end 831 of the corresponding temple 83.

Each of the first and second connectors 82 includes a coupling portion 822 having an abutment face 823, and a hinge portion 824. The coupling portions 822 are respectively provided with first magnets 4 and are formed integrally with the lens rims 81, respectively. The hinge portions 824 are connected pivotally to a hinge part 75 of a plastic hinge member 7′. A magnet 4 is embedded in the hinge member 7′ so that the hinge member 7′ can abut against the coupling portions 822 firmly when the first and second connectors 82 are unfolded.

When the eyeglasses assembly is unfolded as shown in FIG. 11, the abutment faces 823 of the coupling portions 822 abut against each other firmly by means of the attraction of the magnets 4 so that the lens rims 81 are held stably in their unfolded position. In addition, the abutment faces 838 of the first and second temple sections 832, 833 of each temple 83 abut against each other firmly by the attraction of the magnets 835 when each temple 83 is unfolded. Since the eyeglasses assembly can be held firmly and stably in the unfolded position, the user may use only one hand to put on the eyeglasses assembly easily.

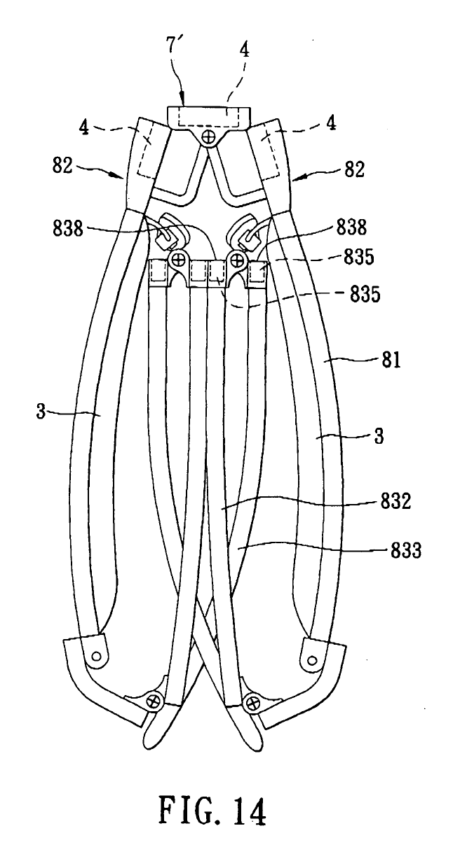

When the eyeglasses assembly is to be folded, the second temple sections 833 are first folded over the first temple sections 832, and the folded first and second temple sections 832, 833 are turned and folded relative to the lens rims 81, as shown in FIG. 13. Finally, the lens rims 81 are turned to move toward each other, as shown in FIG. 14, thereby placing the eyeglass assembly in a compact folded configuration.

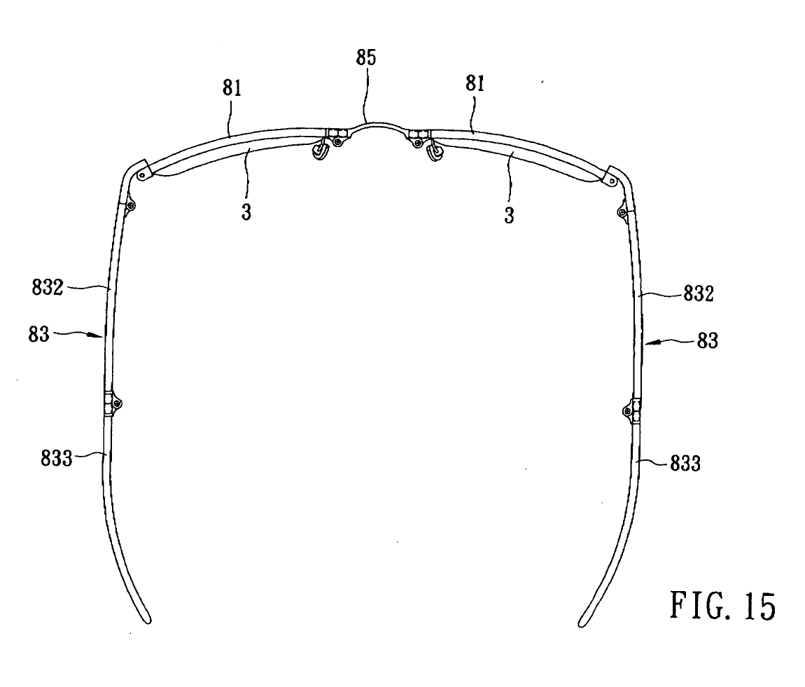

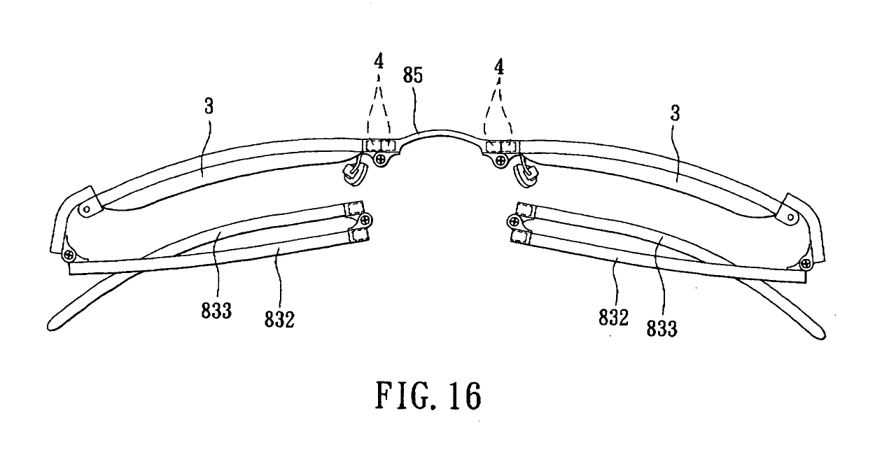

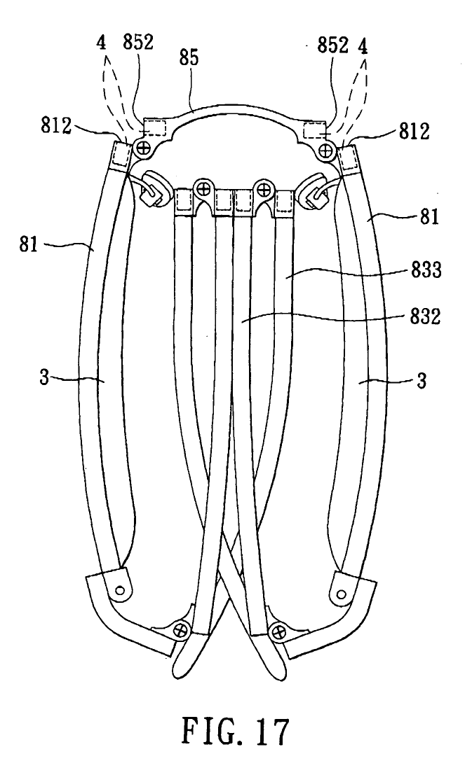

Referring to FIGS. 15, 16 and 17, there is shown a fifth preferred embodiment of the present invention which is substantially similar to the fourth preferred embodiment. Like the fourth embodiment, the eyeglasses assembly of this embodiment includes a pair of lenses 3 held by respective lens rims 81, and a pair of foldable temples 83. However, this embodiment includes an additional component, namely a bridge 85 which has two abutment faces 852 and two magnets 4. The bridge 85 has two ends connected pivotally and respectively to the lens rims 81. The abutment faces 852 of the bridge 85 abut against the abutment faces 812 of the lens rims 81, respectively, when the eyeglasses assembly is unfolded.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A foldable lens assembly comprising:
a pair of lenses;
a frame connected to said lenses, said frame having at least two components which are interconnected pivotally so that said frame can be folded and unfolded, each of said components having at least one abutment face and a magnet;
said abutment faces of said components being movable away from or towards each other when said frame is folded or unfolded, said abutment faces abutting against each other when moving towards each other; and
said magnets providing an attraction force so that said abutment faces abut against each other firmly.

2. The foldable lens assembly as claimed in claim 1, wherein said components include first and second connectors each of which includes a coupling portion connected to one of said lenses, and a hinge portion connected to said coupling portion, said coupling portion having said one abutment face and said magnet, said hinge portions of said first and second connectors being connected pivotally to each other.

3. The foldable lens assembly as claimed in claim 2, wherein said lenses and said first and second connectors of said frame constitute a front lens set, and wherein said foldable lens assembly further includes an eyeglasses assembly which comprises a pair of lens rims, and a bridge connected between said lens rims, said bridge having a magnet, said front lens set being removably attachable to said eyeglasses assembly, both of said first and second connectors abutting against said bridge by an attraction force of said magnets of said first and second connectors and said bridge when said front lens set is attached to said eyeglasses assembly.

4. The foldable lens assembly as claimed in claim 3, wherein said coupling portions are coplanar, said hinge portions being stacked, said frame further having a pivot bolt extending through said hinge portions, said stack of said hinge portions projecting downwardly and rearwardly of said coupling portions and capable of engaging said bridge to limit said front lens set from moving forwardly when said coupling portions are superimposed on said bridge.

5. The foldable lens assembly as claimed in claim 2, wherein said frame further includes a hinge member which includes two hinge parts, and a magnet, said hinge portions of said first and second connectors being connected pivotally to said hinge parts, respectively, said hinge member being capable of abutting against said coupling portions, said magnets of said hinge member and said coupling portions providing an attraction force to place said hinge member in abutment with said coupling portions.

6. The foldable lens assembly as claimed in claim 5, wherein said first and second connectors, said lenses and said hinge member constitute a front lens set, and wherein said foldable lens assembly further includes an eyeglasses assembly which comprises a pair of lens rims, and a bridge connected between said lens rims, said hinge member further having a main part, and a bridge engaging part, said hinge parts provided on left and right sides of said hinge member, said bridge engaging part projecting rearwardly from said main part, said hinge member further having an engaging groove to receive and engage said bridge.

7. The foldable lens assembly as claimed in claim 2, wherein said frame further comprises a pair of lens rims holding respectively said lenses, said lens rims being connected to said coupling portions of said first and second connectors, respectively.

8. The foldable lens assembly as claimed in claim 7, wherein said frame further include a hinge member which has a hinge part, said hinge portions of said first and second connectors being connected pivotally to said hinge part, said hinge member being capable of abutting against said coupling portions.

9. The foldable lens assembly as claimed in claim 1, wherein said components include a pair of lens rims holding respectively said lenses, and a bridge disposed between and connected pivotally to said lens rims, each of said lens rims having said one abutment face and said magnet, said bridge having said magnet and a pair of said abutment faces, said abutment faces of said lens rims abutting against said abutment faces of said bridge, respectively, when said frame is unfolded.

8. The foldable lens assembly as claimed in claim 1, further comprising a temple connected to said frame, said temple being foldable and including first and second temple sections which are pivoted to each other, each of said temple sections having an abutment face and a magnet, said abutment faces of said temple sections being movable away from or towards each other, said abutment faces of said temple sections abutting against each other when moving towards each other, said magnets providing an attraction force so that said abutment faces of said temple sections can abut against each other firmly.
